(19) United States
(12) Patent Application Publication
(10) Pub. No.: US 2024/0002159 A1
(43) Pub. Date: Jan. 4, 2024

(54) CONTROL OF CONVEYOR LINE INSTALLATIONS FOR ITEMS OF GENERAL CARGO

(71) Applicant: Siemens Aktiengesellschaft, Munchen (DE)

(72) Inventors: Michel Tokic, Tettnang (DE); Anja von Beuningen, Erfurt (DE); Martin Bischoff, Aying (DE); Niklas Körwer, Köln (DE); David Grossenbacher, Prag 6-Dejvice (CZ); Kai Heesche, München (DE)

(21) Appl. No.: 18/213,355

(22) Filed: Jun. 23, 2023

(30) Foreign Application Priority Data
Jun. 30, 2022 (EP) 22182200.0

(51) Int. Cl. B65G 43/08

(52) U.S. Cl. CPC B65G 43/08; B65G 2811/095; B65G 2203/0291; B65G 2203/0233

(57) ABSTRACT

A process for controlling a conveyor line for general cargo, the conveyor line including a plurality of consecutive conveyor line portions , each of which is driven by a drive. One or more sensors for detecting general cargo are located on at least some of the conveyor line portions. The drives are controlled by means of a computing unit using a machine learning model. The machine learning model accomplishes this by repeatedly receiving input data including a vector of a fixed length, each vector element being associated with a section of the conveyor line and indicating a current proportional occupancy of the respective section by an item of general cargo. Each conveyor line portion is split into a plurality of the sections of identical size. An apparatus or a system for data processing, a computer program, a computer-readable data carrier and a data carrier signal is also provided.

### CROSS-REFERENCE TO RELATED APPLICATIONS

This application claims priority to EP Application No. 22182200.0, having a filing date of Jun. 30, 2022, the entire contents of which are hereby incorporated by reference.

### FIELD OF TECHNOLOGY

The following relates to the control of conveyor lines for items of general cargo.

### BACKGROUND

Many logistical systems are based on conveyor lines being used to transport items of general cargo such as e.g. packages or individual products. A conveyor line in this instance is usually made up of a plurality of conveyor line portions, which are arranged in succession, with the result that an item of general cargo can be transferred from one conveyor line portion to another, adjoining conveyor line portion without interruption. Each conveyor line portion contains a conveyor belt on which the item of general cargo is moved. Alternatives to conveyor belts are rail systems or multicarrier systems. Multiple such conveyor lines can in turn be combined in an arbitrarily complicated manner, e.g. by virtue of multiple conveyor lines running parallel to one another and opening into a common node.

Each of the conveyor belts of the conveyor line portions is operated using a dedicated drive, with the result that the speed of each conveyor line portion is individually adjustable. This actuation is usually performed using a fast clocking, with the result that the destination at which an item of general cargo is supposed to arrive in particular on the last conveyor line portion can be set very accurately. This requires the conveyor line portions to be accelerated or decelerated in an optimum manner by their respective associated drive on the basis of control signals from a computing unit. Poor control is manifested e.g. by items of general cargo colliding, falling from the conveyor line, not reaching the desired destination or requiring a very long time to arrive there.

### SUMMARY

An aspect relates to demonstrating a process for controlling a conveyor line.

The process according to embodiments of the invention is used for controlling a conveyor line for general cargo. This conveyor line comprises a plurality of consecutive conveyor line portions, each of which is driven by a drive. One or more sensors for detecting general cargo are located on at least some of the conveyor line portions. The drives are controlled by means of a computing unit using a machine learning model. The machine learning model accomplishes this by repeatedly receiving input data comprising a vector of a fixed length, each vector element being associated with a section of the conveyor line and indicating a current proportional occupancy of the respective section by an item of general cargo. The conveyor line is split into a plurality of the sections of identical size in this instance. Apart from this vector of fixed length, the input data can contain further information.

As a result of each of the conveyor line portions having a dedicated drive, they can be individually accelerated or decelerated. This acceleration or deceleration can also comprise an acceleration or deceleration value of 0, i.e. a conveyor line portion can also be operated at least intermittently at constant speed. The selective acceleration or deceleration of each conveyor line portion allows an aim prescribed for the conveyor line to be achieved, e.g. the transported items of general cargo being at defined distances from one another on the last conveyor line portion.

At least one of the conveyor line portions is equipped with a sensor for detecting general cargo. It is possible that some or all of the conveyor line portions have such a sensor, and also that there is provision for multiple sensors per conveyor line portion. The positioning of the sensors in relation to the extent of the conveyor line portions may be the same, e.g. always at the start of a conveyor line portion, but it may also differ from conveyor line portion to conveyor line portion. The sensors are light barriers. Other examples of suitable sensors are: 2D/3D cameras, RFID receivers in combination with RFID tags on the general cargo, induction loops.

The drives of the conveyor line portions are controlled by a computing unit. The latter tells the drives what speed needs to be set or alternatively what acceleration or deceleration.

This is computed by a machine learning model. To this end, the machine learning model requires input data that describe the current state of the conveyor line. These input data are intended in particular to describe where items of general cargo are currently situated on the conveyor line. This general cargo position statement is provided using a vector of fixed length, i.e. every time the machine learning model receives new input data indicating the positions of items of general cargo, the vector indicating these positions has the same number of vector elements. To this end, the conveyor line is notionally split into sections of identical length. In the part of the conveyor line that is relevant to control, e.g. from the first to the last sensor, there is thus no part of the conveyor line that does not belong to one of the sections; this part is thus split into the sections entirely. The individual conveyor line portions can be split into different numbers of sections in this instance, since their lengths can differ from one another. Each section corresponds to a vector element. The respective vector element indicates what proportion of the section is occupied by an item of general cargo. Each section can be occupied by an item of general cargo entirely, in part or not at all. E.g. an item of general cargo can be situated on the front half of a section and the rear third of a preceding section.

The input data provided to the machine learning model are current information, i.e. they describe the current state of the conveyor line. Of course, this does not prevent a certain time delay that may exist between the ascertainment of the state of the conveyor line and the reception of the input data by the machine learning model.

In one development of embodiments of the invention, the machine learning model receives updated input data with a temporal clocking, and with the same clocking it outputs information about a speed to be set for each conveyor line portion. The faster the clocking, the more accurate the control of the conveyor line. Modern conveyor lines operate using a control clocking in the millisecond range.

According to one configuration of embodiments of the invention, the proportional occupancy is ascertained from measurement results from sensors and speeds of conveyor line portions. This allows a combination of measurement and computation to be used to describe the state of the conveyor line. In particular, the current proportional occupancy for a specified item of general cargo can be ascertained over time by virtue of a sensor detecting the item of general cargo and assigning this measurement result to the respective section(s) containing the applicable position, computational ascertainment of the position of the item of general cargo taking place up to the next sensor by using the speed of the respective conveyor line portion, and this computation result being assigned to the respective section(s) containing the applicable position, then the next sensor detecting the item of general cargo and assigning this measurement result to the respective section(s) containing the applicable position. The vector values indicating the occupancy of the sections therefore move from one sensor, through the line, to the next sensor over the course of time. This change of use of the measured values when the item of general cargo is detected by a sensor and use of computed values for the line between the sensors can be applied for the entire length of the conveyor line. It holds that when a sensor detects an item of general cargo, this is entered into the vector. This also holds for the case in which the computational tracking of the item of general cargo between the sensors indicates a different time of arrival at the sensor.

Each vector element advantageously indicates the current proportional occupancy using a non-binary value, using a numerical value between 0 and 1. In this case, e.g. 0 can represent “no general cargo on the section”, 1 can represent “section entirely occupied by an item of general cargo”, and 0.5 can represent “half of the section is occupied by an item of general cargo”.

In one development of embodiments of the invention, the input data further comprise:
current information concerning at least one position of at least one point on the last conveyor line portion; this can be a marker such as e.g. a zero line, or a target region in which an item of general cargo is meant to end up. This point moves at the respective speed of the conveyor line portion. and/or
information concerning the current speeds of the conveyor line portions, and/or
current measurement results from the sensors; this includes which sensor is currently detecting or not detecting an item of general cargo.

In one configuration of embodiments of the invention, the machine learning model is trained before the conveyor line is controlled, wherein the training is accomplished by prescribing input data comprising the vector of the fixed length for the machine learning model, the vector elements being ascertained from a simulation of the conveyor line. The input data for training the machine learning model are intended to be of the same kind as those for the actual control. In contrast to the actual control, the data for training do not arise from the real system, however, but rather from a virtual one. This allows interaction between the machine learning model and the simulation without general cargo being damaged or a great deal of time being taken up by measurements on a genuine system.

It is particularly advantageous if the training takes place as reinforcement learning, in which a reward or penalty is ascertained by employing a target function comprising:
arrival at a prescribed point on the, the last, conveyor line portion by an item of general cargo; this arrival or nonarrival would bring about a reward or penalty and/or
collision between multiple items of general cargo on the conveyor line; this event would bring about a penalty and/or
similarity of speeds of adjacent conveyor line portions; a similar speed of two successive conveyor line portions is advantageous for transferring the item of general cargo from one to the other conveyor line portion in terms of avoiding friction effects, and so this would bring about a reward and/or
the maintaining of a minimum or target distance between two items of general cargo. This distance can be measured by one of the sensors, on the last conveyor line portion.

The process according to embodiments of the invention and/or one or more functions, features and/or steps of the process according to embodiments of the invention and/or of one of its configurations can proceed in a computer-aided manner. Said process can be carried out and implemented, respectively, for example by means of one or more computers, processors, application-specific integrated circuits (ASICs), digital signal processors (DSPs) and/or what are known as “field-programmable gate arrays” (FPGAs). It can also be carried out at least in part in a cloud and/or in an edge computing environment. One or more interacting computer program products (non-transitory computer readable storage medium having instructions, which when executed by a processor, perform actions) are used to allow it to proceed in a computer-aided manner. If multiple programs are used, these can be jointly stored on a computer and executed by said computer, or on different computers at different locations. Since this is synonymous in terms of function, “the computer program” and “the computer” are worded in the singular in the present case.

### BRIEF DESCRIPTION

Some of the embodiments will be described in detail, with reference to the following figures, wherein like designations denote like members, wherein:

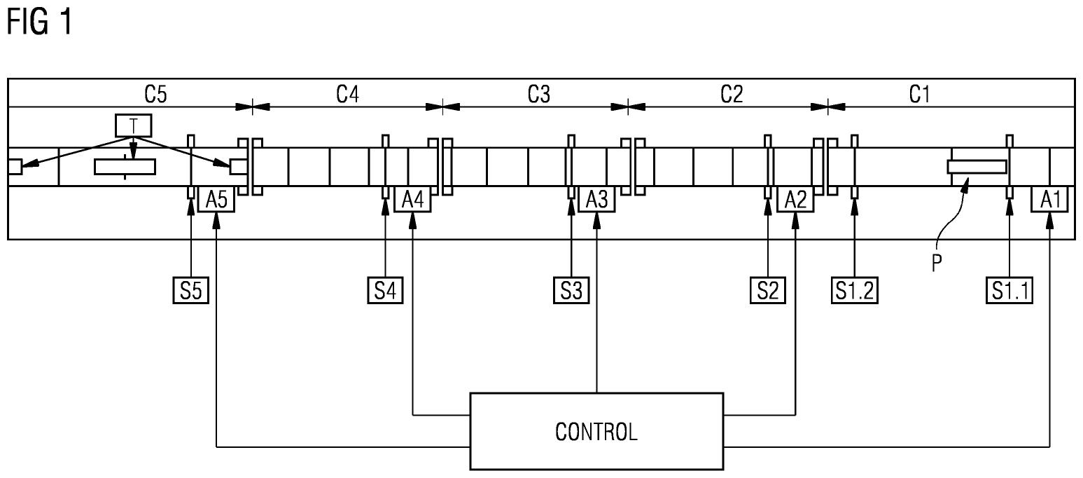

FIG. 1: shows a conveyor line;

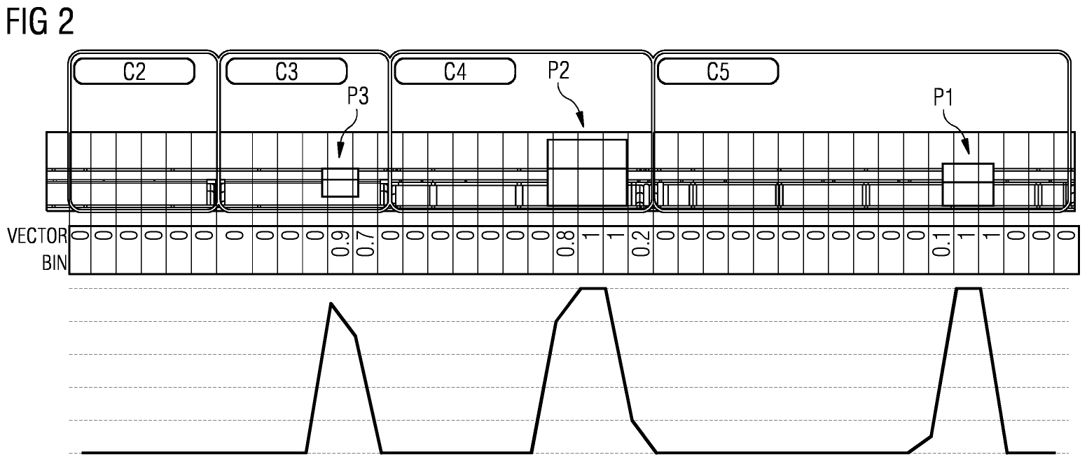

FIG. 2: shows a split for a conveyor line into bins;

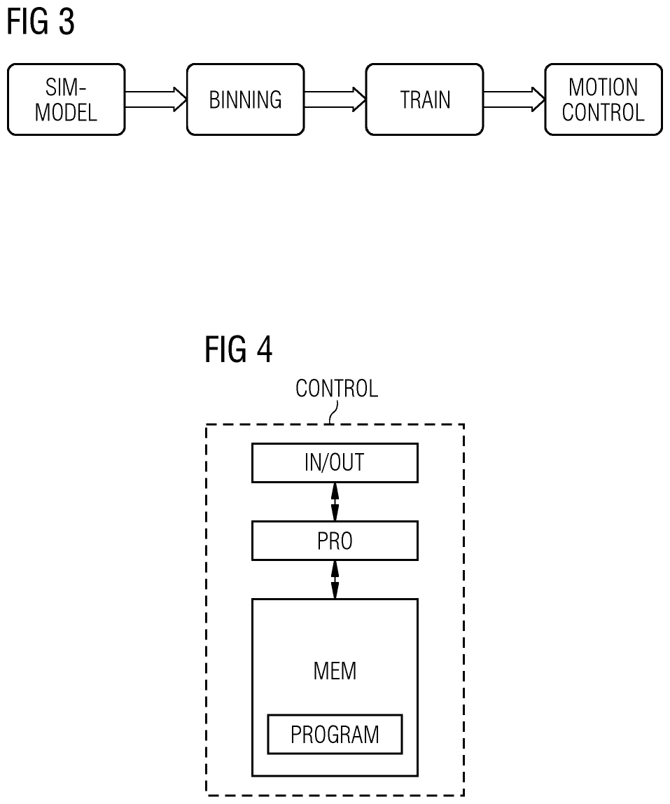

FIG. 3: shows a flowchart;

FIG. 4: shows a control unit for controlling the movement of a conveyor line; and

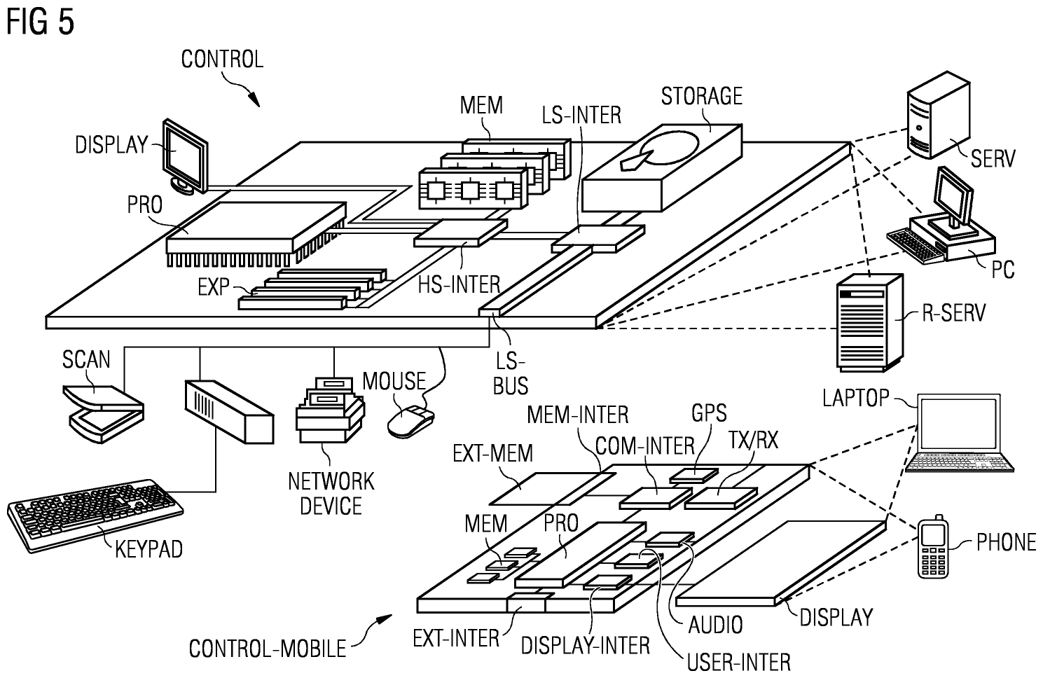

FIG. 5: shows a more detailed representation of the control unit.

### DETAILED DESCRIPTION

Conveyor lines having multiple individually actuatable conveyor belt sections are often used in intralogistics or in the production setting in general. FIG. 1 shows such a conveyor line, which can be used e.g. for a packaging machine. Here, products on the conveyor line need to be accelerated/decelerated in order to deliver the product to suit the clock frequency of a flow-wrapping machine, not shown, at the end of the conveyor line. In the illustration, the product P coming from the right is transported to the left by the conveyor line portions in the form of the conveyor belts C1, C2, C3, C4, C5. The product P is an inherently arbitrary item of general cargo. The conveyor belts C1, C2, C3, C4, C5 may be of identical length or may have different lengths.

Each of the conveyor belts C1, C2, C3, C4, C5 has a respective associated drive A1, A2, A3, A4, A5. The conveyor belts C1, C2, C3, C4, C5 can be individually accelerated or decelerated by appropriately actuating the drives A1, A2, A3, A4, A5 by means of a control unit CONTROL, illustrated by the arrows, symbolizing the actuation signals, from the control unit CONTROL to the respective drive A1, A2, A3, A4, A5. The aim of this individual control of the movement of the conveyor belts C1, C2, C3, C4, C5 is to place the product at a specified destination T on the last conveyor belt C5. The items of general cargo are supplied to the conveyor line by way of the conveyor belt C1, which serves as a transfer unit and which, as shown, is also in the form of a conveyor line portion. In general, therefore, general cargo that enters at random, both in regard to times and in regard to size, is available, which needs to be put down at prescribed positions.

In order to render the control unit CONTROL able to generate suitable actuation signals for accelerating and decelerating the drives A1, A2, A3, A4, A5, the conveyor belts C1, C2, C3, C4, C5 are provided with sensors. In the example in FIG. 1, the sensors S1.1, S1.2, S2, S3, S4, S5 are distributed as follows: the first conveyor belt Cl has two sensors, the sensor S1.1 at the start and the sensor S1.2 at the end, all of the other conveyor belts each having a sensor S2, S3, S4 and S5. The sensors may e.g. not be positioned directly at the start/end of the individual conveyor belts, but rather may be at a short distance from the start of the conveyor belt; in general, however, they may be disposed at any positions. It is also not necessary for every conveyor belt to be provided with one or more sensors. The sensors S1.1, S1.2, S2, S3, S4, S5 are light barriers. These output the binary values LOW and HIGH, HIGH meaning that there is a product in the light barrier. Furthermore, there may be provision for further sensors for ascertaining the speeds of the conveyor belts C1, C2, C3, C4, C5, such as e.g. speed sensors for detecting the speed of the drives A1, A2, A3, A4, A5, current sensors for detecting motor currents of the drives A1, A2, A3, A4, A5, etc. Alternatively, the speeds of the conveyor belts C1, C2, C3, C4, C5 can be assumed to be known from the actuation signals of the control unit CONTROL.

The conveyor line shown in FIG. 1 is a simple example. More complex conveyor lines can be found for example in package sorting installations, which can comprise multiple such fingers, which in turn include multiple successive conveyor belt sections. A specific example of this is what is known as a “dynamic gapper”, an automatically controlled drive application recently used in intralogistics. Each finger of a package sorting installation is thus designed as shown in FIG. 1, in principle. Package sorting installations are employed inter alia for singularizing packages of different or identical sizes. The individual fingers of the package sorting installations are conveyor lines running parallel to one another. Arranged at the end of these conveyor lines is a combining unit, called a merger, to which the last conveyor line portions in the conveying direction transfer the items of general cargo that they transport. At an output of the combining unit, there is a single output conveyor line. The package flow is combined on this outgoing conveyor belt. The package sorting installation is thus intended to singularize the products on the outgoing belt.

The individual acceleration and deceleration of the conveyor belts of the fingers allows general cargo transported on the various fingers to be transported to the combining unit at staggered times. The combining unit is therefore rendered able to convey the item of general cargo to the output conveyor line in such a way that two temporally successive items of general cargo are always at a prescribed defined minimum distance from one another. In order to avoid collisions on the conveyor belt at the junction, it is very useful if packages running parallel are separated as early as possible.

Conveyor lines running in an arbitrarily complex manner are conceivable and in use. Whatever the specific configuration of the conveyor line may be, it is the task of the control unit CONTROL to determine and set the optimum speeds of the individual conveyor belts at any time and in any given situation, distinguished by different numbers, sizes and positions of the individual products. What speeds are optimum is dependent on the function and objective of the respective conveyor line.

The determination of optimum control is technically very challenging. Conventional controllers track the product positions essentially on the basis of the light barrier signals. One particular problem in this case is that transitions between two conveyor belts are difficult to model manually on account of the friction and different speeds of the two belts. To improve matters, the installation can be equipped with additional sensors such as cameras that are able to measure the product positions at any time very accurately. A disadvantage, however, is the considerable costs for these expensive additional sensors. Multiple cameras are sometimes needed for the whole conveyor line so that accurate measurements can be taken. Moreover, the drives are intended to be actuated using fast temporal clocking of e.g. 4 ms. The evaluation of the camera images needs to take place correspondingly quickly. Such image processing in order to detect the product positions can deliver this temporal clocking—if at all—only with very expensive hardware.

The text below explains how the implementation of control of the installation can be facilitated using artificial intelligence. This is accomplished by training a machine learning model (subsequently ML model), which then undertakes motion control for the conveyor belts C1, C2, C3, C4, C5 as part of the control unit CONTROL during the actual operation of the conveyor line. It is possible to train in particular artificial neural networks, recurrent neural networks, convolutional neural networks, perceptrons, Bayesian neural networks, autoencoders, variational autoencoders, Gaussian processes, deep learning architectures, support vector machines, data-driven regression models, k-nearest neighbor classifiers, physical models and/or decision trees. Suitable training methods are in particular methods from the field of reinforcement learning, for example policy gradient processes.

A system model for the conveyor line is used for the purpose of training the ML model. This digital twin of the conveyor line may be e.g. a simulation based on physical equations (in particular using Unity or NX MCD) or a neural dynamic model (typically a recurrent neural network).

The ML model gets the following state information from the system model for the training:
Belt position of the last conveyor belt Each conveyor belt has a marker or the like, the belt position indicating where said marker is currently located. This is relevant because it allows the current location of the destinations T to be ascertained.
The current speeds of the conveyor belts During interaction between the ML model and the system model for training purposes, these match the speeds prescribed by the ML model.
Product positions of the items of general cargo situated on the conveyor line The product positions within the system model are determined as follows:

Product registration and measurement: The product length of a newly arriving product on the first conveyor belt Cl is measured at the first sensor S1.1, the arrival of said product being detected by way of the state change LOW-HIGH at this sensor S1.1. As soon as the signal is at HIGH, the time-dependent speeds v(C1)_t of the conveyor belt Cl are integrated with respect to time over time. The integration is terminated for the transition HIGH-LOW at the sensor S1.1, and the product length 1(P) is obtained from this. To avoid measurement inaccuracies, it is advantageous to have the first conveyor belt travel at a constant speed for the purpose of product registration.

Product tracking: a computational position update is performed. The time-dependent position of the product x(P)_t at the time t is recalculated by adding to each time step the current speed of the respective conveyor belt C on which the product is presumably, that is to say according to the computed product tracking, currently situated: x(P)_t=x(P)_{t-1}+v(C)_t.

Modelling a conveyor belt change, i.e. a product transition from one conveyor belt to the next, e.g. from C1 to C2, is difficult. The real physical properties of the conveyor belt transition are reproduced in the system model. These real physical conditions comprise in particular the coefficients of friction of the belt surfaces. That is to say that all physical relationships, including friction, are modelled and computed. From this, it is possible to ascertain whether a product slips a little on a slower conveyor belt when transitioning from a faster conveyor belt to the latter, or conversely does not immediately move along at the conveyor belt speed on a faster conveyor belt when transitioning from a slower conveyor belt to the latter.

Product de-registration: On arrival at the last sensor S5 on the last conveyor belt C5, the tracking of the relevant product position is also stopped.
The current state of the sensors, that is to say a binary signal stating whether or not a product is travelling through the light barrier.

The ML model gets these four outlined pieces of state information from the system model. They are made available to the ML model with the clocking intended for actuating the drives, e.g. every 4 ms. This is regarded as a time slice by the ML model. In this way, the AI can ascertain actuation information for the drives with this clocking. To successfully train the ML model, it is desirable for the state information gotten from the system model to have the Markov property. That is to say that the next state needs to be anticipable by the ML model using the current state information and the action taken by the ML model, i.e. the setting of the speeds of the individual conveyor belts. The text below describes how state information meeting this requirement can be acquired on the basis of the system model described above. Input features suitable for successful use of the ML model are thus intended to be provided. The following problem exists here for the problem domain under consideration, i.e. for the described circumstances of the conveyor line, with regard to the state information relating to the product positions:

It is important to know that ML models require a defined, constant number of input variables, or input features. This can be explained by the fact that a neural network regards the input data as a vector and multiplies them by a matrix of weights that need to be set as part of the training. However, this does not apply to the described circumstances of the product positions on the conveyor line: at different times there may be a different number of products on the conveyor line at the same time. A mandatory prerequisite for the ML model is an input vector of constant length, however, this length corresponding to the constant number of input variables. To this end, it would be possible to proceed e.g. in such a way that the product positions of the n frontmost products are transferred to the ML model. Since, as described, the hitting of a slot on the last conveyor belt may be the target function to be learned for the ML model, this would work per se. It would not lead to optimum results, however, since there is the possibility of other products further back on the conveyor belt being masked out. To take account of this and thereby get input data for the ML model with high quality, the volume of input data would need to vary, since the number of packages can vary over time. A neural network cannot handle this, however.

To avoid the outlined problem, the binary light barrier signals are converted into features that an ML model in the form of a neural network can process. FIG. 2, which shows a detail from a conveyor line with a split into bins of equal size, is used to explain the approach. The detail shown in FIG. 2 shows the conveyor belts C2, C3, C4, C5, the direction of travel of the belts being to the right. The product P1 is situated on the conveyor belt C5, the product P2 is situated on the conveyor belt C4 and the product P3 is situated on the conveyor belt C3. The conveyor belts C2, C3, C4, C5 are notionally split into sections BIN, which are shown schematically beneath the conveyor line. In this case, the sections BIN have the same extent in the direction of travel. This artificial grid formed by the sections BIN covers the whole conveyor line.

Each of the sections BIN is assigned a value between 0 and 1, proportional to the occupancy of the respective section BIN by a product. In this case, 0 means that the respective section BIN is empty. A 1 means that the respective section BIN is covered completely by a product. If only part of the respective section BIN is covered by a product, the respective section BIN gets a value corresponding to the percentage proportion of its occupancy. These values form a product position state vector VECTOR, the values of which are entered into the sections BIN by way of illustration according to the positions of the products P1, P2, P3, located on the conveyor belts C2, C3, C4, C5. This product position state vector VECTOR, containing the occupancy for each section BIN and therefore indicating the product positions, always has a constant length and can therefore be used as an input feature relating to the product positions for the ML model. This facilitates the modelling of the AI by means of a neural network in the first place. The bottom of FIG. 2 contains a graphical representation of the values of the product position state vector VECTOR. This representation is used only for illustrative purposes; there is no provision for any processing of this continuous response of the vector values by the ML model.

The described product position state vector VECTOR is consistent with a complete snapshot of the conveyor line with all the products situated thereon, in accordance with a camera image. The ML model therefore requires very few time slices (approximately 10) to make optimum decisions regarding motion control, since it has a general view of the system available in the form of all of the sections BIN. Alternative approaches, on the other hand, e.g. when modelling using a recurrent neural network, that involve only the light barrier signals and conveyor belt speeds being considered would require many time slices (approximately 60) to be provided at high clock speeds in order to allow the ML model to estimate the Markov state.

As already explained, the sections BIN have the same extent in the direction of travel, e.g. 6 cm. For greater clarity, this extent of the sections BIN has been shown much larger in the figure. The size of the sections BIN is freely selectable per se. An essential criterion is the training time required by the ML model, which increases greatly as the number of sections BIN increases. A contrary criterion that should be considered is that, should the expanse of the sections BIN be chosen to be very large, it can happen that multiple packages are situated in one section BIN. A Markov state is reliably gotten when the sections BIN are chosen to be small enough, with the result that no more than one product can be situated entirely in one section BIN.

It is advantageous if the division into sections BIN is matched to the distances between the sensors. That is to say that the boundary between two adjacent sections BIN is located at the position of each sensor. This is useful in particular when, as explained later on, the product tracking at the sensors is synchronized. The synchronization at the positions of the sensors generates local modelling or local binning on the observed line portions. Each line portion contributes a previously defined number of features in the form of the vector values of the respective sections BIN, which are part of the whole product position state vector VECTOR for the ML model.

Furthermore, the ML model can also infer from the product position state vector VECTOR when multiple products have collided and then travel over the conveyor line together. The distance between the rising and falling edges in the graphical representation at the bottom of FIG. 2 and the product length known on the basis of the registration can be used to ascertain that multiple products are passing through a light barrier successively without a gap. This usually needs to be avoided, since separation of the products is no longer attainable in a selective manner or products could be damaged in the event of a collision.

The ML model uses the described state information containing the product position state vector VECTOR to learn a control strategy for the conveyor line. The four pieces of state information by and large form a vector of constant length in this instance.

In particular reinforcement learning methods are suitable for this training of the ML model. A target function, the type of which is dependent on the desired mode of operation of the conveyor line, is defined for the training in this instance. The hitting or missing of targets can then be rated by means of reward and/or penalty, as a result of which the learning effect arises for the ML model. In the case of a package sorting installation, it is possible for e.g. concurrently activated sections BIN of two conveyor belts to be penalized by an applicable negative reward. The binning also allows a neural network to e.g. detect collisions between two products, since the sections BIN produce a neighborhood relationship. This is relevant in particular when collisions are intended to be negatively penalized in reinforcement-learning-based control in order to avoid them. Without the binning grid, there would be no way of representing collisions that occur in an input vector of defined length. Furthermore, the binning also facilitates collision detection during linear operating time (O(N) with N=number of packages) instead of O(N log(N)), where the latter would result from the package positions initially being sorted and then adjacent packages being checked for collision each time. This facilitates fast control of the system in real time. A further aspect that can usefully be implemented in the target function is that the speed differences between adjacent conveyor belts should be small; this prevents slippage and similar effects during the belt transitions.

Following completion of the training, the AI can undertake the actual control, i.e. work on the real system. To this end, it is identical to or part of the control unit CONTROL. The ML model therefore computes speeds for the individual conveyor belts and the actuation signals required therefor for the drives. That is to say that the output from the ML model during actual operation is a specified speed per conveyor belt per time slice, corresponding to the clocking of the control.

During actual operation, the system model is no longer needed because the data now come from the real system. The input data that the ML model gets for controlling the conveyor line are compiled in exactly the same way as the state information during training. This means that the ML model gets the following data with the clocking required for controlling the conveyor line:
Belt position of the last conveyor belt
The current speeds of the conveyor belts These do not necessarily match the speeds prescribed by the ML model. This is because during actual operation, when the trained ML model controls the conveyor line, smaller variations can arise, e.g. as a result of the control signals reaching the drives with a delay or deceleration/acceleration of the conveyor belts taking a little time.
Product positions of the items of general cargo situated on the conveyor line This is accomplished by using the actually measured signals from the sensors, and then, as explained above with regard to the product tracking in the system model, computing values for the positions between the sensors on the basis of the speeds of the conveyor belts. For the belt transitions, a simple approach to a solution is to use the speed v(C1)_t of C1 while the greatest part of the product is still situated on C1. Only if more than half of the product is situated on C2 are the speeds v(C2)_t of C2 used to continue to track the product position x(P)_t. Alternatively, however, the two speeds can also be used in proportion, depending on what proportion of the product length l(P) is situated on the respective conveyor belt.

This type of product tracking requires only the first and last sensors to be used. This has the disadvantage that inaccurate estimation of the product positions, e.g. primarily at the conveyor belt transitions, produces errors that accumulate over time. The change from a first conveyor belt to a second is critical because the product does not necessarily immediately assume the speed of the second conveyor belt on the second conveyor belt. This happens on account of different coefficients of friction of the conveyor belt surfaces and different speeds of the conveyor belts. If e.g. the first conveyor belt has a much higher speed than the second, the product will slip at least a little bit before it is slowed to the speed of the second conveyor belt by the static friction. It is therefore useful to operate the product tracking locally per conveyor belt. In a specific exemplary embodiment from FIG. 1, the product P on the conveyor belt C1 is computationally tracked on the conveyor belt C2 from sensor S1.2 to sensor S2, that is to say that errors from the product transition to conveyor belt C2 are tracked only as far as the sensor S2. When the sensor S2 is reached, the product registration on the conveyor belt C2 then takes place, the product length not needing to be determined again. The position used for the product is the measured value from the sensor S2, and from here onward the product tracking is restarted. The product tracking from the sensor S2 to sensor S3 on conveyor belt C3 then takes place, etc., as a result of which synchronization is produced at each light barrier.

For the synchronization at the positions of the sensors, it is moreover advantageous to use the falling edge in the graphical representation at the bottom of FIG. 2. As already explained, a transition from conveyor belt to conveyor belt can result in the product slipping, this being slowed after a time, with the result that the product travels on the respective conveyor belt without slipping. This slippage is more likely to have finished when the rear end of the product leaves the light barrier than when the front part of the product reaches the light barrier.

In this way, the product position state vector VECTOR is obtained on the basis of measured values from the sensors in combination with computational product tracking between the sensors.
The current state of the sensors, that is to say the actual measurement signal stating whether or not a product is travelling through the light barrier.

Which of the outlined input features are used by the ML model for control and to what extent is not prescribed for the ML model. This has been worked out by the ML model during the training.

A particular advantage of the described use of an ML model for the purposes of motion control in industrial machines is that working out the control strategy to be applied in the ML model takes a matter of days, whereas writing/programming conventional control algorithms would require years.

The outlined use of the ML model is also an inexpensive and not very hardware-intensive solution, as no expensive additional sensors such as e.g. cameras are needed for tracking the products, since the grid formed by the sections BIN over the whole conveyor line is similar to a camera image. In particular, the high clock speeds demanded by the motion control can be produced without problems, which means that control using a 4 ms or even shorter timing pulse is possible. If, alternatively, a camera image were to be evaluated in order to determine the positions of all the products, a clocking of approximately 100 ms would have to be expected.

In summary, FIG. 3 shows a flowchart relating to the outlined approach. The first step SIM-MODEL comprises producing the simulation model that represents the real conveyor line. A second step BINNING comprises defining the sections BIN in order to be able to produce suitable input vectors for the ML model from the simulation model. In a third step TRAIN, the ML model learns optimum control of the conveyor line. In a fourth step MOTION CONTROL, the ML model takes the behavior learned in the preceding step as a basis for controlling the conveyor line by prescribing the speeds or accelerations for the various conveyor belts. This is the phase of inference, in which the weights learned by the neural network during the TRAIN step are retained and applied to the real system.

FIG. 4 shows how the control unit CONTROL that implements the ML model may be designed. Whereas the parts explained more thoroughly below are present a single time in the figure, it is also possible for them to be present as multiples, e.g. as a distributed system. In this way, the functionality of the control unit CONTROL can be split over multiple, possibly hierarchically interlinked, systems. Said system or systems may be situated in proximity to the conveyor line or at another location.

The control unit CONTROL comprises a computing unit or a processor PRO. Said processor is connected to a memory MEM, which stores a computer program PROGRAM. The memory MEM is a nonvolatile computer-readable data storage medium. Storage can take place in any manner suitable for ensuring readability by a computing unit, such as by magnetic storage, e.g. by means of floppy disk, optical storage, e.g. by means of CD, magneto-optical storage, ROM (read-only memory) storage, RAM (random access memory) storage, EPROM (erasable programmable read-only memory), EEPROM (electrically erasable programmable read-only memory), flash memory.

Execution of the instructions of the program PROGRAM in the processor PRO allows the steps of the procedure explained above to be carried out. This applies in particular to the TRAIN and MOTION CONTROL steps in FIG. 3, while there is the possibility of the SIM-MODEL and BINNING steps already having been performed beforehand. To this end, the processor PRO is connected to an input and output unit IN/OUT that can be used to exchange information between the control unit CONTROL and other components and/or a user. This interface can be configured in a suitable manner, e.g. by radio or by cable, and the communication can take place using suitable standards.

FIG. 5 shows an illustration of how the control unit CONTROL in FIG. 4 may be configured: this may be a generic computer CONTROL or a mobile generic computer control unit CONTROL-MOBILE. In this instance, the generic computer CONTROL represents different types of digital computer devices, such as e.g. desktop computers, workstations, servers, blade servers, mainframes, or other suitable devices. The mobile generic computer CONTROL-MOBILE accordingly represents different types of mobile digital computer devices, such as e.g. laptops, PDAs, cell phones or smartphones, or other suitable devices. If FIG. 5 is used to demonstrate and explain components that can be used specifically and in detail, this is intended to be understood as illustrative; the realization of embodiments of the invention is not limited to these components.

The computer CONTROL comprises a processor PRO, a memory MEM and, in between, a high-speed interface HS-INTER. Furthermore, high-speed expansion ports EXP and a low-speed interface LS-INTER are connected to the high-speed interface HS-INTER. The low-speed interface LS-INTER has the storage device STORAGE and the low-speed bus LS-BUS connected to it. The components PRO, MEM, STORAGE, HS-INTER, EXP, LS-INTER are connected by suitable connections/buses and may be installed on a common motherboard.

Whereas the components of the computer CONTROL are shown as singles in figure it is also possible to provide for some or all of these components multiple times. The computer CONTROL can also comprise multiple interconnected computers, which may be situated at different locations.

The processor PRO can process instructions that are intended to be executed in the computer CONTROL, the instructions being able to be stored in particular in the memory MEM or in the storage device STORAGE. Information, in particular results of the processing in the processor PRO, can be graphically output by means of a GUI on a display that is connected to the high-speed interface HS-INTER, such as the screen DISPLAY.

The memory MEM is used for storing information within the computer CONTROL. This can be a volatile memory or a nonvolatile memory. It can comprise multiple memory cells. The storage device STORAGE is a mass storage device for a computer-readable medium. To this end, it can comprise e.g. a floppy disk drive, a hard disk, a drive for optical storage disks, a tape device, a flash memory storage device, or a series of devices, e.g. in a storage area networks configuration.

The high-speed interface HS-INTER is responsible for bandwidth-intensive processes within the computer CONTROL, whereas the low-speed interface LS-INTER is used for processes with less bandwidth requirement. To this end, the high-speed interface HS-INTER is connected to the memory MEM, the screen DISPLAY, possibly via a graphics processor, and the high-speed expansion ports EXP, which can take various expansion cards. Connected to the low-speed interface LS-INTER are the storage device STORAGE and the low-speed bus LS-BUS, on which there can be low-speed expansion ports. The latter can have various communication connections, e.g. USB, Bluetooth, Ethernet or wireless Ethernet. These can have various input and/or output apparatuses connected to them, e.g. a keypad KEYPAD, a mouse MOUSE, a scanner SCAN or a network device NETWORK DEVICE, such as a switch or a router. This distribution of tasks between the two interfaces HS-INTER and LS-INTER is illustrative and may also be organized differently.

The computer CONTROL can be implemented in different ways, as can be seen at the right-hand edge of the figure. E.g. it can be implemented as a personal computer PC, as a standard server SERV or a group of such servers, such as e.g. a server farm, or as a rack server system R-SERV or part of such a system.

The mobile computer CONTROL-MOBILE comprises a processor PRO, a memory MEM, an input and output apparatus DISPLAY, a communication interface COM-INTER and a transceiver TX/RX. The components PRO, MEM, COM-INTER, TX/RX are connected by suitable connections/buses and may be installed on a common motherboard or in another suitable manner. Furthermore, there may be provision for a further storage device, such as e.g. a microdrive or the like, in order to provide further storage options.

The processor PRO can execute instructions within the mobile computer CONTROL-MOBILE, in particular those stored in the memory MEM. It can be implemented as a chip or chipset that contains one or more analog or digital process units. The processor PRO may be responsible inter alia for coordinating the other components of the mobile computer CONTROL-MOBILE, such as e.g. for controlling the user interface(s), for applications running on the mobile computer CONTROL-MOBILE and for the wireless communication of the mobile computer CONTROL-MOBILE. A transmission of information takes place between the user of the mobile computer CONTROL-MOBILE and the processor PRO via the user interface USER-INTER, for example by voice input/output, and via the display interface DISPLAY-INTER, for example by text input/output. The input and output apparatus DISPLAY may be based e.g. on TFT LCD (thin-film-transistor liquid crystal display) or OLED (organic light-emitting diode) technology.

Furthermore, there is provision for an external interface EXT-INT connected to the processor PRO, said external interface being able to be used for near field communication between the mobile computer CONTROL-MOBILE and other devices. The external interface EXT-INT can be used to communicate by wire and/or by radio.

The memory MEM is used for storing information within the mobile computer CONTROL-MOBILE and, to this end, can be implemented e.g. as a volatile or nonvolatile memory comprising one or more storage units. Additionally, there may be provision for an expansion memory EXT-MEM connected to the mobile computer CONTROL-MOBILE via the expansion interface MEM-INTER, e.g. an interface for an SIMM (single inline memory module) or a SIM (subscriber identity module). The expansion memory EXT-MEM provides additional storage capacity for the mobile computer CONTROL-MOBILE and can also store various applications. E.g. the expansion memory EXT-MEM can be used as a security module for the mobile computer CONTROL-MOBILE by virtue of identification information being stored therein.

The mobile computer CONTROL-MOBILE can communicate wirelessly via the transceiver TX/RX, which, to this end, has means for digital signal processing. The communication interface COM-INTER allows communication using suitable protocols, such as e.g. GSM, SMS, MMS, CDMA, TDMA, PDC, WCDMA, CDMA2000, GPRS, EDGE, UMTS, LTE, and 5th- or higher-generation communication protocols. In addition to the transceiver TX/RX used for this purpose, there may be provision for a transceiver for near field communication, such as e.g. Bluetooth, WiFi or the like, which is not shown. Finally, there may also be provision for a GPS module GPS in order to be able to use location-related services. The audio codec AUDIO can be used to convert received audio information, which can comprise in particular instructions from a user, into digital information that can be processed by the mobile computer CONTROL-MOBILE; accordingly, the audio codec AUDIO can be used to generate sound information perceivable to the user.

As can be seen on the right-hand side of the figure, the mobile computer CONTROL-MOBILE is implemented as a smartphone PHONE or laptop LAPTOP.

The interaction between the user and the computer CONTROL or the mobile computer CONTROL-MOBILE can take place in a wide variety of ways and is not limited to the specific illustration in FIG. 5. Any transmission of information by sensor (visible, audible, touch-perceptible) is possible.

While the components of the computer CONTROL and of the mobile computer CONTROL-MOBILE have been described separately, it is also possible to employ one computer that comprises components of both the computer CONTROL and the mobile computer CONTROL-MOBILE.

The computer program PROGRAM shown in FIG. 4 can be stored in any of the memories MEM, STORAGE, EXT-MEM in FIG. 5, including in a manner distributed over multiple memories. Furthermore, storage can alternatively or additionally also be effected in a cloud-based manner.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A process for controlling a conveyor line for general cargo, wherein
the conveyor line comprises a plurality of consecutive conveyor line portions, each of which is driven by a drive,
one or more sensors for detecting general cargo are located on at least some of the consecutive conveyor line portions,
the drives are controlled by means of a computing unit using a machine learning model, the machine learning model repeatedly receiving input data comprising a vector of a fixed length, each vector element being associated with a section of a conveyor line and indicating a current proportional occupancy of the respective section by an item of general cargo, the conveyor line being split into a plurality of the sections of identical size.

2. The process as claimed in claim 1, wherein
the machine learning model receives updated input data with a temporal clocking, and with the same clocking outputs information about a speed to be set for each conveyor line portion.

3. The process as claimed in claim 1, wherein
the current proportional occupancy is ascertained from measurement results from the one or more sensors and speeds of conveyor line portions.

4. The process as claimed in claim 3, wherein
the current proportional occupancy for a specified item of general cargo is ascertained over time by virtue of
a sensor detecting the item of general cargo and assigning a measurement result to the respective section(s)containing an applicable position,
computational ascertainment of the applicable position of the item of general cargo taking place up to a next sensor by using the speed of the respective conveyor line portion, and a computation result being assigned to the respective section(s) containing the applicable position,
the next sensor detecting the item of general cargo and assigning the measurement result to the respective section(s) containing the applicable position.

5. The process as claimed in claim 1, wherein
each vector element indicates the current proportional occupancy using a non-binary value, using a numerical value between 0 and 1.

6. The process as claimed in claim 1, wherein the input data further comprise:
current information concerning at least one position of at least one point on a last conveyor line portion, and/or
information concerning current speeds of the consecutive conveyor line portions, and/or
current measurement results from the one or more sensors.

7. The process as claimed in claim 1, wherein the machine learning model is trained before the conveyor line is controlled, wherein the training comprises prescribing input data comprising the vector of the fixed length for the machine learning model, the vector elements being ascertained from a simulation of the conveyor line.

8. The process as claimed in claim 7, wherein the training takes place as reinforcement learning, in which a reward or penalty is ascertained by employing a target function comprising:
arrival at a prescribed point on the last conveyor line portion by an item of general cargo, and/or
collision between multiple items of general cargo on the conveyor line, and/or
similarity of speeds of adjacent conveyor line portions, and/or
the maintaining of a minimum or target distance between two items of general cargo.

9. An apparatus or system for data processing, comprising means for carrying out the process as claimed in claim 1.

10. A computer program product, comprising a computer readable hardware storage device having computer readable program code stored therein, said program code executable by a processor of a computer system to implement a method as claimed in claim 1.

11. A computer-readable storage medium containing the computer program as claimed in claim 10.

12. A data carrier signal that transmits the computer program as claimed in claim 10.
